(19) United States
(12) Patent Application Publication
(10) Pub. No.: US 2019/0050880 A1
(43) Pub. Date: Feb. 14, 2019

(54) SYSTEMS AND METHODS FOR IMPROVED SHARED TRANSPORTATION SERVICES AND IMPROVED QUEUED TRANSPORTATION SERVICES

(71) Applicant: SC INNOVATIONS, INC., San Francisco, CA (US)

(72) Inventors: Sunil Paul, San Francisco, CA (US); Jahan Khanna, San Francisco, CA (US); Robert Wong, Burlingame, CA (US); Robert Moran, San Francisco, CA (US); Thomas Gellatly, San Francisco, CA (US)

(21) Appl. No.: 16/160,932

(22) Filed: Oct. 15, 2018

Related U.S. Application Data
(63) Continuation of application No. 14/794,425, filed on Jul. 8, 2015.
(60) Provisional application No. 62/037,445, filed on Aug. 14, 2014.
(60) Provisional application No. 62/025,129, filed on Jul. 16, 2014.
(60) Provisional application No. 62/023,307, filed on Jul. 11, 2014.

(51) Int. Cl. G06Q 30/02; G06Q 10/02

(52) U.S. Cl. CPC G06Q 30/0207; G06Q 10/02

(57) ABSTRACT

Systems and methods for providing discounts for shared transportation are described. A transportation server receives, from a client device of a first user, a first request for a shared transportation service. The transportation server receives, from a client device of a second user, a second request to join the shared transportation service. The transportation server calculates a first price for the first user for the shared transportation service based on at least a portion of a shared transportation service trip. The transportation server calculates a second price for the second user for the shared transportation service trip based on at least the portion of a shared transportation service trip.

### RELATED APPLICATIONS

This application is a Continuation of U.S. application Ser. No. 14/794,425, filed on 8 Jul. 2015, which is a nonprovisional of and claims priority to U.S. Provisional Application No. 62/023,307, filed on 11 Jul. 2014; U.S. Provisional Application No. 62/025,129, filed on 16 Jul. 2014; and U.S. Provisional Application No. 62/037,445, filed on 14 Aug. 2014, all of which are incorporated by reference herein.

### FIELD OF THE INVENTION

The present disclosure generally relates to transportation services and, more specifically, to systems and methods for providing transportation discounts in shared rides.

### BRIEF DESCRIPTION OF THE DRAWINGS

Some embodiments are illustrated by way of example and not of limitation in the figures of the accompanying drawings.

FIG. 1 is a schematic diagram showing an example of a system for providing a transportation marketplace, according to some embodiments;

FIG. 2 is a block diagram showing example components of a transportation server, according to some embodiments;

FIG. 3 is a block diagram showing example components of a client device, according to some embodiments;

FIG. 4 is a flowchart showing an example method of providing discounts in exchange for a shared transportation service, according to some embodiments;

FIG. 5 is a block diagram showing example components of a transportation server, according to some embodiments;

FIG. 6 is a block diagram showing example components of a client device, according to some embodiments;

FIG. 7 is a flowchart showing an example method of queuing a transportation service, according to some embodiments;

FIG. 8 is a diagram showing an eligibility area, according to some embodiments;

FIG. 9 is a block diagram showing example components of a transportation server, according to some embodiments;

FIG. 10 is a block diagram showing example components of a client device, according to some embodiments;

FIG. 11 is a flowchart showing an example method of dynamically modifying a route of a shared transportation service, according to some embodiments;

FIG. 12 is a diagram showing a user booking a shared transportation service that is currently transporting another user to a drop-off location, according to some embodiments;

FIG. 13 is a diagram showing a shared transportation service dynamically modified to allow for a maximum number of users to utilize the shared transportation service; and

FIG. 14 is a block diagram of a machine in the example form of a computer system within which a set of instructions, for causing the machine to perform any one or more of the methodologies discussed herein, may be executed, according to some embodiments.

### DETAILED DESCRIPTION OF THE INVENTION

Example systems and methods for providing transportation discounts for multiple passengers of a shared transportation service are described. In the following description, for purposes of explanation, numerous specific details are set forth in order to provide a thorough understanding of example embodiments. It will be evident, however, to one skilled in the art that the present technology may be practiced without these specific details.

A transportation server may provide an online environment in which drivers and passengers may connect with one another for shared transportation services. The transportation server determines discount payments required by each passenger of a shared transportation service trip. In some embodiments, discount payment amounts required by each passenger may be similar. In other embodiments, discount payment amounts required by each passenger may be different. In some embodiments, a payment may be offered to a driver in exchange for the driver accepting an additional passenger for the shared transportation service trip.

A first passenger may use a software application on the first passenger's computing device to send a request for a shared transportation service. In some embodiments, the software application displays a discount price the first passenger will be required to pay for the shared transportation service.

In response to the request for the shared transportation service sent from the first passenger's computing device, the transportation server may match the first passenger with a driver who will perform the shared transportation service. The transportation server books the first passenger for the shared transportation service to be performed by the driver. The transportation server may send a verification message to the first passenger's computing device. The purpose of the verification message is to verify whether the first passenger intended to request the shared transportation service—as opposed to a non-shared transportation service. The verification message may provide to the first passenger a selectable option to opt-out of the requested shared transportation service. In some embodiments, the purpose may be to further notify the first passenger of other information required for the shared transportation service.

If the transportation server receives a response to the verification message from the first passenger's computing device, the transportation server cancels the first passenger's request for the shared transportation service. If the transportation server does not receive a response to the verification message from the first passenger's computing device within a period of time, the transportation server notifies one or more drivers of the request for the shared transportation service through a software application on each drivers' respective computing device, and a driver may choose to perform the shared transportation service which will include the first passenger and one or more additional passengers.

A second passenger may use the software application on the second passenger's computing device to view a representation of the shared transportation service established between the driver and the first passenger. In some embodiments, the software application displays a discount price the second passenger will be required to pay for joining the shared transportation service established between the driver and the first passenger.

The second passenger may use the software application on the second passenger's computing device to send a request to join the shared transportation service established between the first passenger and the driver. The driver may choose to accept the second passenger's request to join the shared transportation service via the driver's computing device. In some embodiments, the transportation server sends to the driver's computing device a payment amount to be paid to the driver in exchange for accepting the second passenger's request to join the shared transportation service. The driver's computing device sends data to the transportation server representative of the driver's acceptance of the second passenger's request to join the shared transportation service. In some embodiments, the transportation server sends data to the driver's computing device indicating a selectable option to cancel the second passenger's request to join the shared transportation service. In other embodiments, the transportation server sends data to the first passenger's computing device indicating a selectable option to cancel the second passenger's request to the join the shared transportation service.

The transportation server establishes the shared transportation service between the driver, the first passenger and the second passenger. In one embodiment, the transportation server sends shared transportation service data to the first passenger's computing device and the second passenger's computing device.

The shared transportation service data sent from the transportation server to the first passenger's computing device can be based on the first passenger's desired starting location and desired destination location and can also be based on the second passenger's desired starting location and desired destination location. In some embodiments, in order to be respectful of the second passenger's privacy, the shared transportation service data based on the second passenger's desired starting location and desired destination that is sent to the first passenger's computing device may be based on a result of the transportation server modifying (or obscuring) the second passenger's desired starting location and desired destination. For example, the transportation server sends a zip code or cross-streets associated with the second passenger's desired destination for display on the first passenger's computing device.

The shared transportation service data sent from the transportation server to the second passenger's computing device can be based on the second passenger's desired starting location and desired destination location and can also be based on the first passenger's desired starting location and desired destination location. In some embodiments, in order to be respectful of the first passenger's privacy, the shared transportation service data based on the first passenger's desired starting location and desired destination that is sent to the second passenger's computing device may be based on a result of the transportation server modifying (or obscuring) the first passenger's desired starting location and desired destination. For example, the transportation server sends a zip code or cross-streets associated with the first passenger's desired destination for display on the second passenger's computing device.

By establishing the shared transportation service between the driver, the first passenger and the second passenger, the transportation server defines a shared transportation service trip (hereinafter “shared trip”) to be performed by the driver. The shared trip will transport the first passenger to a first destination desired by the first passenger (hereinafter “First Destination”). The shared trip will also transport the second passenger to a second destination desired by the second passenger (hereinafter “Second Destination”). In addition, the first passenger and the second passenger will accompany each other during at least a portion of the shared trip. Once the shared trip is established, the transportation server determines payments required by the first passenger and the second passenger in exchange for the shared trip.

In some embodiments, the First Destination and the Second Destination are the same location. In other embodiments, the First Destination and the Second Destination are not the same location. In some embodiments, the first passenger and the second passenger begin the shared trip from the same location. In other embodiments, the first passenger and the second passenger begin the shared trip from different locations.

In some embodiments, the driver performing the shared trip logs shared trip events by entering at least one input into the driver's computing device. For example, the driver enters a shared trip event into the driver's computing device each time a respective passenger begins and ends the shared trip. The driver's computing device sends data representative of each logged shared trip event to the transportation server. In some embodiments, the transportation server uses the data representative of a shared trip event to initiate fulfillment of a discount payment from a passenger of the shared trip.

The transportation server may facilitate payment between the driver and the passengers of a shared trip. In particular, the transportation server determines discount payments required from both the first and second passengers in exchange for the shared trip. For example, the first passenger's discount payment determined by the transportation server may be less than a payment determined by the transportation server for a non-shared transportation service that transports the first passenger to the First Destination. In addition, the second passenger's discount payment may be less than a payment determined by the transportation server for a non-shared transportation service that transports the second passenger to the Second Destination.

In some embodiments, an amount of a first discount payment required by the first passenger in exchange for the shared trip may be different than an amount of a second discount payment required by the second passenger in exchange for the shared trip. In one embodiment, the difference in the amounts of the first and second discount payments is based at least on a detour portion(s) of the shared trip the first passenger had to experience due to the second passenger's desired starting location and/or desired destination. In other embodiments, the difference in amounts of the first and second discount payments may be based at least on a detour portion(s) of the shared trip the second passenger had to experience due to the first passenger's desired starting location and/or desired destination. It is understood that a detour portion of a shared trip is a portion of the shared trip that a passenger would not have had to experience but for the starting location and/or destination location of another passenger of the shared trip.

In other embodiments, the difference in the amounts of the first and second discount payments is based at least on a portion of the shared trip during which either the first passenger or the second passenger is unaccompanied. In other embodiments, the difference in the amounts of the first and second discount payments is based at least on a portion of the shared trip during which the first and the second passenger accompany each other during the shared trip.

In some embodiments, the difference in the amounts of the first and second discount payments is based at least on a portion of the shared trip during which the first passenger accompanies the second passenger due to the second passenger's desired destination (i.e. the Second Destination) being different than the first passenger's desired destination (i.e. the First Destination). In other embodiments, the difference in the amounts of the first and second discount payments is based at least on a portion of the shared trip during which the second passenger accompanies the first passenger due to the first passenger's desired destination (i.e. the First Destination) being different than the second passenger's desired destination (i.e. the Second Destination).

In some embodiments, the difference in the amounts of the first and second discount payments is based at least on a portion of the shared trip during which the first passenger is unaccompanied due to the second passenger's desired destination (i.e. the Second Destination) being different than the first passenger's desired destination (i.e. the First Destination). In other embodiments, the difference in the amounts of the first and second discount payments is based at least on a portion of the shared trip during which the second passenger is unaccompanied due to the first passenger's desired destination (i.e. the First Destination) being different than the second passenger's desired destination (i.e. the Second Destination).

In some embodiments, the difference in the amounts of the first and second discount payments is based at least on a portion of the shared trip during which the first passenger is unaccompanied due to the second passenger's starting location being different than the first passenger's starting location. In other embodiments, the difference in the amounts of the first and second discount payments is based at least on a portion of the shared trip during which the second passenger is unaccompanied due to the first passenger's starting location being different than the second passenger's starting location.

In other embodiments, the difference in the amounts of the first and second discount payments may be based at least on a portion of the shared trip required due to the first passenger's starting location and/or desired destination. The difference in the amounts of the first and second discount payments may be based at least on a portion of the shared trip required due to the second passenger's starting location and/or desired destination.

It is understood that shared transportation services that define a shared trip amongst a plurality of passengers may be provided to the passengers at a discount or at a premium rate, which may be automatically and dynamically based on any suitable characteristics and/or factors associated with the particular shared transportation service requested. For example, a particular request for shared transportation may be fulfilled at a discounted rate based on a location of a driver and/or a location of a passenger near the time of the shared transportation request, based on a destination associated with the shared transportation request, and the like. Providing adjusted pricing may create a capability to discount or otherwise modify the characteristics of a shared transportation service trip based on identifying a location relating to a driver and/or passenger (e.g., a starting location, a destination location, etc.) as a hotspot location that may be associated with the adjusted pricing. A hotspot location may be a geographical location of any suitable size (e.g., a particular radius around a city center, a landmark, a neighborhood, etc.) that is associated with adjusted pricing (e.g., a discount) adjustable based on characteristics of a shared transportation request.

The transportation server may determine whether a requested shared transportation service is associated with a hotspot location (e.g., travels through a hotspot, travels within a hotspot, etc.) based on any suitable factors, such as the particular starting location and the destination location requested by the passenger, a passenger's location near the time of the request (e.g., using a service for detecting a location of a passenger's computing device, such as global positioning system (GPS)), a destination location estimated based on a passenger's calendar entry or any other suitable predictive technology, a destination location determined by a driver based on any variety and/or combination of user inputs (e.g., advice from a passenger, an intermediate stop requested and/or required by a driver and/or passenger, a driver indicating the end of a trip, etc.), and the like.

A hotspot location may be established in any suitable manner, such as by a sponsor responsible for a monetary discount associated with the hotspot location, a driver, a passenger, the transportation server, an entity associated with a pickup and/or drop-off location, a crowd-sourced decision-making manner of determining a hotspot location (e.g., through a voting system), an entity in a rewards program who is rewarded by being given the ability to set a particular hotspot location (e.g., which in some embodiments may be automated), a third-party associated with any of the above, and the like.

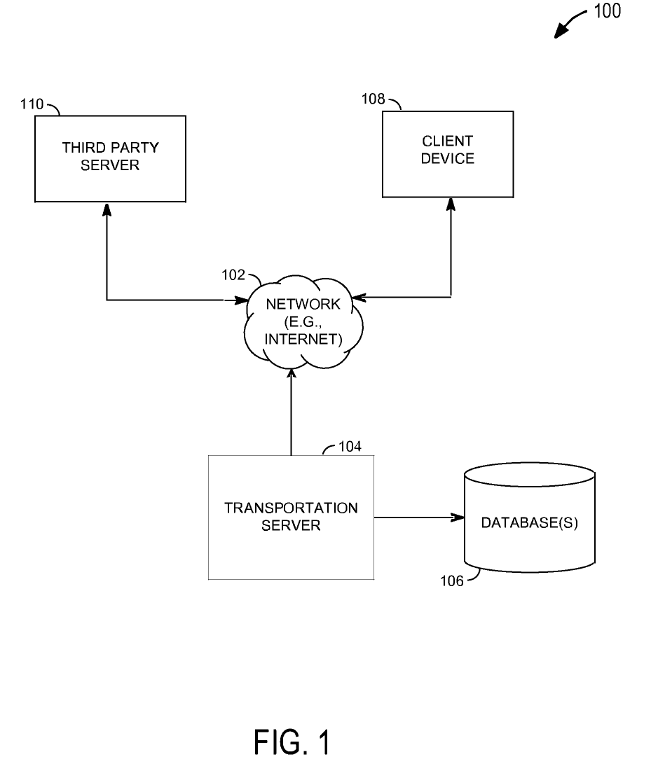

FIG. 1 is a schematic diagram showing an example of a system 100 for providing a transportation marketplace. The system 100 includes a transportation server 104, one or more client devices 108, and a third party server 110. The components of the system 100 are connected directly or over a network 102, which may be any suitable network. In various embodiments, one or more portions of the network 102 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The transportation server 104 may include a network-addressable computing system that may facilitate communication between drivers and passengers and may obtain and utilize data relevant to drivers and/or passengers stored in the database(s) 106.

The client device 108 may be any suitable computing device that may be used by a driver and/or a passenger to communicate with one another, such as a smart phone, a personal digital assistant (PDA), a mobile phone, a personal computer, a laptop, a computing tablet, or any other device suitable for communication.

The third party server 110 may be any server that may be accessed by the transportation server 104 and/or the client device 108 to obtain information relevant to transportation services (e.g., public transportation, location-based services, etc.).

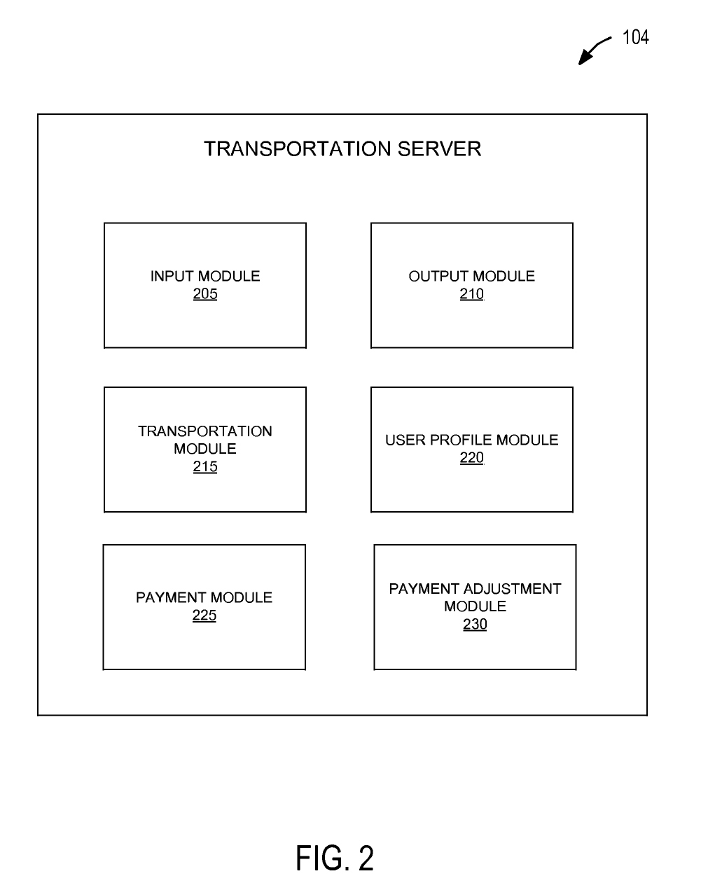

FIG. 2 is a block diagram showing example components of a transportation server 104. The transportation server 104 includes an input module 205, an output module 210, a transportation module 215, a user profile module 220, a payment module 225, and a payment adjustment module 230.

The input module 205 may be a hardware-implemented module which receives and processes any inputs from one or more components of system 100 of FIG. 1 (e.g., one or more client devices 108, third party server 110, etc.). The inputs may include requests related to transportation, payment information, and the like. For example, the inputs may be related to request for shared transportation.

The output module 210 may be a hardware-implemented module which sends any outputs to one or more components of system 100 of FIG. 1 (e.g., one or more client devices 108, third party server 110, etc.). The outputs may include information about available drivers, passengers requesting transportation, and the like. For example, the outputs may be related to one or more passengers that have requested shared transportation.

The transportation module 215 may be a hardware-implemented module which manages, facilitates, and controls transportation requests (such as shared transportation requests) from passengers and/or drivers. For example, when a request for shared transportation is received from one or more passengers, the transportation module 215 may determine and generate a list of drivers available to fulfill the request.

The user profile module 220 may be a hardware-implemented module which manages, controls, stores, and accesses information associated with drivers and/or passengers. The information may be stored in and accessed from the database(s) 106 shown in FIG. 1. The information managed by the user profile module 220 may include any information associated with a driver(s) and/or passenger(s), such as preferences, vehicle information, background information of a driver, ratings of drivers and/or passengers, payment information of drivers and/or passengers, and the like.

The payment module 225 may be a hardware-implemented module which manages, facilitates, and controls payments between drivers and passengers. The payment module 225 may also determine suggested prices associated with shared transportation requests based on the characteristics of the request (e.g., distance to be traveled, etc.).

The payment adjustment module 230 may be a hardware-implemented module which manages, facilitates, determines, identifies, and calculates adjustment payments (e.g., a discount, a premium, etc.) based on characteristics of the shared transportation service requested by one or more passengers.

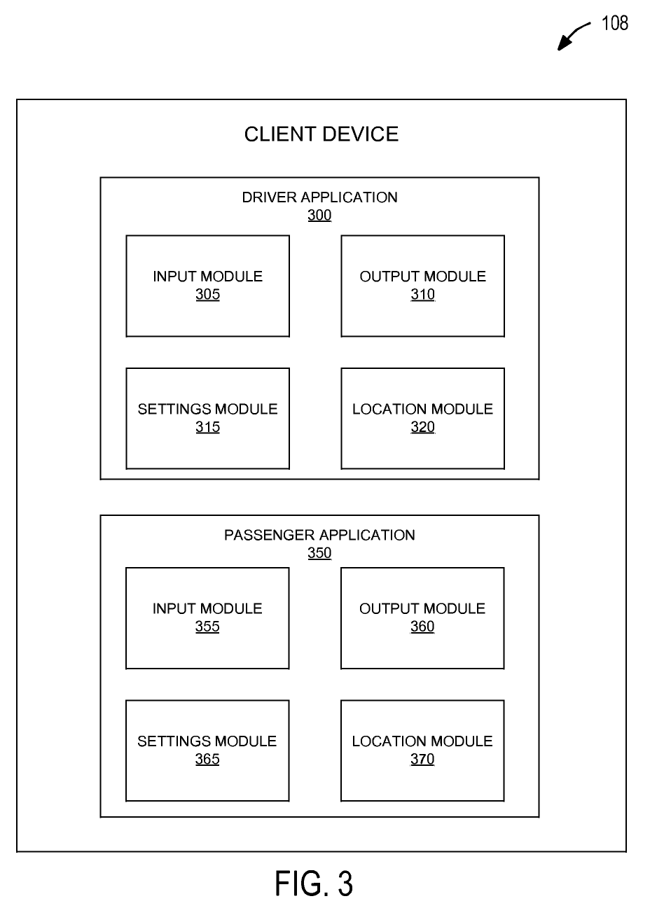

FIG. 3 is a block diagram showing example components of a client device 108. The client device may be a computing device of a driver(s) and/or a passenger(s) and may include a driver application 300 and/or a passenger application 350.

The driver application 300 may be a software application associated with the transportation server 104 of FIGS. 1-2. The driver application may include an input module 305, an output module 310, a settings module 315, and a location module 320.

The input module 305 may be a hardware-implemented module that may receive and process any inputs from a driver, including inputs related to responses to shared transportation requests from one or more passengers, inputs related to preferences of the driver, inputs related to events during a particular shared transportation service trip, and the like.

The output module 310 may be a hardware-implemented module that may send any outputs to one or more components of system 100 of FIG. 1 (e.g., other client devices 108, third party server 110, transportation server 104, etc.). The outputs may include responses to shared transportation service requests, location of the client device 108, and the like.

The settings module 315 may be a hardware-implemented module that may manage, store, and access settings indicated by a driver, such as a starting location, destination location, price, a rating of a passenger, a casual carpool preference, and the like. It is understood that a starting location can be a passenger's desired pick-up location and a destination location can be a passenger's desired drop-off location.

The location module 320 may be a hardware-implemented module that may determine a location of the client device 108. The location module 320 may determine location in any suitable manner (e.g., using a third party server 110, GPS capabilities on the client device 108, etc.).

The passenger application 350 may be a software application associated with the transportation server 104 of FIGS. 1-2. The passenger application may include an input module 355, an output module 260, a settings module 265, and a location module 370.

The input module 355 may be a hardware-implemented module that may receive and process any inputs from a passenger, including inputs related to a shared transportation service request, inputs related to preferences of the passenger, and the like.

The output module 260 may be a hardware-implemented module that may send any outputs to one or more components of system 100 of FIG. 1 (e.g., other client devices 108, third party server 110, transportation server 104, etc.). The outputs may include shared transportation service requests, location of the client device 108, and the like.

The settings module 365 may be a hardware-implemented module that may manage, store, and access settings indicated by a passenger, such as a starting location, a destination location, a price preference, a driver rating, a driver response rate, a casual carpooling preference, a preferred estimated time of arrival, and the like.

The location module 370 may be a hardware-implemented module that may determine a location of the client device 108. The location module 370 may determine location in any suitable manner (e.g., using a third party server 110, GPS capabilities on the client device 108, etc.).

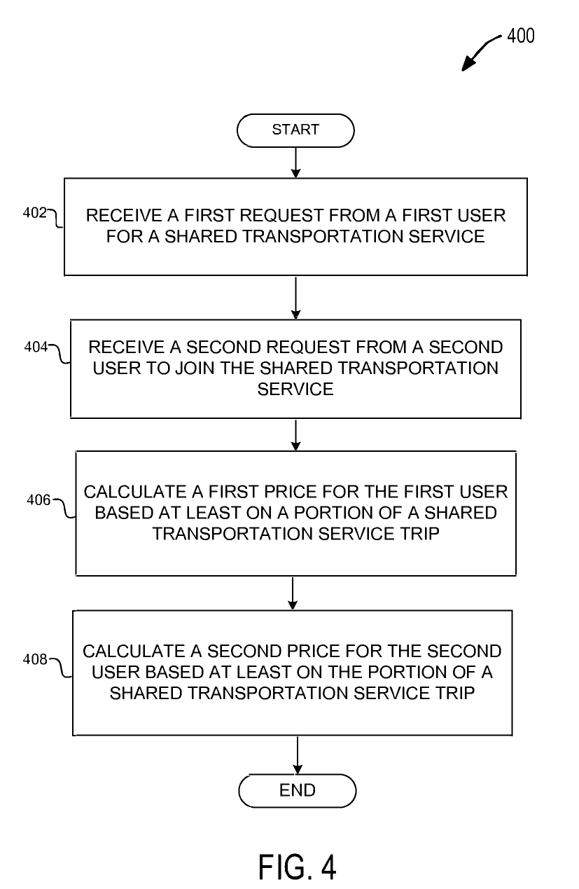

FIG. 4 is a flowchart showing an example method 400 of providing discounts for shared transportation. The operations of FIG. 4 may be performed by components of the transportation server 104 of FIG. 2.

In operation 402, the hardware-implemented input module 205 receives a first request from a first user for a shared transportation service. For example, the first request may be sent from a computing device associated with a first passenger.

In operation 404, the hardware-implemented input module 205 receives a second request from a second user to join the shared transportation service. For example, the second request may be sent from a computing device associated with a second passenger. Based on the first request and the second request, the transportation server 104 defines a shared trip between the first user and the second user.

In operation 406, the hardware-implemented payment adjustment module 230 calculates a first price for the first user based at least on a portion of a shared transportation service trip.

In operation 408, the hardware-implemented payment adjustment module 230 calculates a second price for the second user based at least on the portion of a shared transportation service trip. In one embodiment, the first price may be different than the second price due to the first user or the second user being unaccompanied during the portion of the shared transportation service trip.

It is understood that, in various embodiments, any and/or all of the modules of the transportation server 104 can be involved in performing operations 404, 406 and 408.

In some embodiments, a first passenger may book a transportation service to be performed by a driver via a 3^{rd} party server. The first passenger's computing device and/or the driver's computing device may send data representative of the transportation service booked via the 3^{rd} party server to the transportation server.

The transportation server may send data to the second passenger's computing device representative of the transportation service booked via the 3^{rd} party server. The second passenger's computing device may send a request to the transportation server to join the transportation service booked via the 3^{rd} party server. Based on the second passenger's request to join, the transportation server establishes a shared trip between the first passenger, the second passenger and the driver. The transportation server determines a payment required by the second passenger in exchange for joining the transportation service booked via the 3^{rd} party server. The transportation server determines payments to be dispersed to the first passenger and/or the driver of the transportation service booked via the 3^{rd} party server.

Payments dispersed to the first passenger and/or the driver can be determined in exchange for the first passenger and/or the driver providing the data representative of the transportation service booked via the 3^{rd} party server to the transportation server.

In some embodiments, the transportation server may match the first passenger and the second passenger based on their respective desired starting locations and/or their respective desired destinations. In some embodiments, the first passenger and the second passenger may send a request to be matched for a shared trip to the transportation server. The transportation server may establish a shared trip based on matching the first passenger and the second passenger. Upon establishing the shared trip for the first passenger and the second passenger, the transportation server identifies a driver indicated as available to perform the shared trip. The transportation server books an available driver to perform the shared trip. In some embodiments, the transportation server sends a request for an available driver to a 3^{rd} party server in order to book an available driver to perform the shared trip for the first passenger and the second passenger.

In some embodiments, the transportation server establishes a shared trip for a first passenger before receiving a request from a second passenger to join the shared trip. The transportation server determines a discount payment required by the first passenger in exchange for the shared trip. The discount payment is also determined prior to receiving the request from the second passenger to join the shared trip. Once the transportation server has established the shared trip for the first passenger and has determined the first passenger's required payment, the transportation server sends data representative of the shared trip to the second passenger's computing device or to a 3^{rd} party server. The transportation receives a request from the second passenger, sent from the computing device or the 3^{rd} party server, to join the shared trip. The transportation server adds the second passenger to the shared trip based on receipt of the second passenger's request to join the shared trip.

In some embodiments, the transportation server establishes a transportation service to be performed by a driver on behalf of a first passenger. The first passenger's computing device or the driver's computing device sends to the transportation server a price for a potential passenger to join the transportation service. The transportation server sends data representative of the price to join the transportation service to the second passenger's computing device. The transportation server receives an acceptance of the price from the second passenger's computing device. Based on receipt of the acceptance of the price, the transportation server establishes the transportation service as a shared trip between the first passenger and the second passenger.

In some embodiments, the first passenger is also the driver performing the shared transportation service. The transportation server sends data representative of the transportation service performed by the first passenger to the second passenger's computing device. The transportation server receives a request to join the transportation service performed by the first passenger from the second passenger's computing device. Based on receipt of the request to join, the transportation server books the second passenger for the transportation service performed by the first passenger. The transportation server determines a payment required by the second passenger in exchange for joining the transportation service performed by the first passenger.

In some embodiments, a request for a shared transportation service may relate to a hotspot location associated with a particular characteristic, and the request may be provided to one or more drivers relevant to the particular characteristic. For example, the request may be related to an estimated time of arrival, a rating of a driver, a type of driver, a type of vehicle, and the like, and the request may be sent to drivers associated with one or more of these characteristics.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Example systems and methods for queuing transportation services are described. In the following description, for purposes of explanation, numerous specific details are set forth in order to provide a thorough understanding of example embodiments. It will be evident, however, to one skilled in the art that the present technology may be practiced without these specific details.

Embodiments described below provide for an automated method for convenient, efficient allocation of personal transportation and other on-demand transportation resources and transportation services over a data communications network. These embodiments may also be extended for use in a variety of scenarios in which a mobile resource requires scheduling and allocation of that resource.

A transportation server may provide an online environment in which drivers and passengers may connect with one another for transportation services. The transportation server determines payments required by each passenger of a transportation service. In some embodiments, a transportation service may comprise a trip from a starting location to a destination location. In some embodiments, a transportation service may be a trip from a pick-up location associated with a passenger to a drop-off location associated with the passenger. In various embodiments, an upcoming transportation service may be a transportation service to be performed by a particular driver, from a pick-up location to a drop-off location, after the particular driver completes a transportation service that is currently in progress.

In some embodiments, a driver may be currently performing a transportation service to transport a first passenger from the first passenger's pick-up location to the first passenger's drop-off location. The transportation server may request and receive a current location of the driver's computing device while the driver is performing the transportation service for the first passenger.

The transportation server determines an eligibility area. For example, the transportation server defines the eligibility area as an area surrounding the first passenger's drop-off location. The transportation server receives an indication that the transportation service performed by the driver is currently located within the eligibility area while transporting the first passenger. Based on receiving the indication that the transportation service performed by the driver is currently located within the eligibility area, the transportation server determines the driver is eligible to be booked for performing an upcoming transportation service for one or more passengers.

In some embodiments, the transportation server determines the driver is eligible to be booked for performing an upcoming transportation service for one or more passengers that are currently located within a particular distance from the first passenger's drop-off location. In some embodiments, the transportation server determines the driver is eligible to be booked for performing an upcoming transportation service for one or more passengers that are currently located within a particular distance from the eligibility area. The transportation server may send data to one or more computing devices indicating the driver is eligible to be booked for performing an upcoming transportation service.

A second passenger may use a software application on the second passenger's computing device to view a representation of the upcoming transportation service to be performed by the driver. In some embodiments, the second passenger views the representation of the upcoming transportation service while the driver is performing the transportation service to transport the first passenger to the first passenger's drop-off location. The transportation server may determine a payment required by the second passenger for the upcoming transportation service. The transportation server may send data indicating the payment to be displayed on the second passenger's computing device while the driver is performing the transportation service to transport the first passenger to the first passenger's drop-off location.

The transportation server determines an expected time of arrival at a pick-up location of the second passenger for the upcoming transportation service to be performed by the driver. In some embodiments, the transportation server determines the expected time of arrival for the upcoming transportation service while the driver is performing the transportation service for the first passenger. The transportation server determines a first amount of time until the transportation service arrives at the drop-off location of the first passenger. The transportation server determines a second amount of time until the transportation service arrives at the pick-up location of the second passenger from the drop-off location of the first passenger. The transportation server determines the expected time of arrival at the pick-up location of the second passenger based at least on the first amount of time and the second amount of time. The transportation server may send data indicating the expected time of arrival to be displayed on the second passenger's computing device while the driver is performing the transportation service to transport the first passenger to the first passenger's drop-off location.

The second passenger may use the software application on the second passenger's computing device to send a request to book the upcoming transportation service to be performed by the driver. The transportation server receives the request to book the upcoming transportation service from the second passenger's computing device while the driver performs the transportation service on behalf of the first passenger.

In some embodiments, the transportation server may send to the driver's computing device a payment amount to be paid to the driver in exchange for accepting the second passenger's request to book the upcoming transportation service. In some embodiments, while the driver performs the transportation service on behalf of the first passenger, the driver's computing device sends data to the transportation server representative of the driver's acceptance of the second passenger's request to book the upcoming transportation service.

The transportation server may facilitate payment between the driver and the second passenger upon completion of the upcoming transportation service.

It is understood that transportation services, including upcoming transportation services, may be provided to one or more passengers at a discount or at a premium rate, which may be automatically and dynamically based on any suitable characteristics and/or factors associated with the particular transportation service requested. For example, a particular request for an upcoming transportation service may be fulfilled at a discounted rate based on a location of a driver and/or a location of a passenger near the time of the request for the upcoming transportation service, based on a destination (i.e. drop-off location) associated with the request for the upcoming transportation service, and the like.

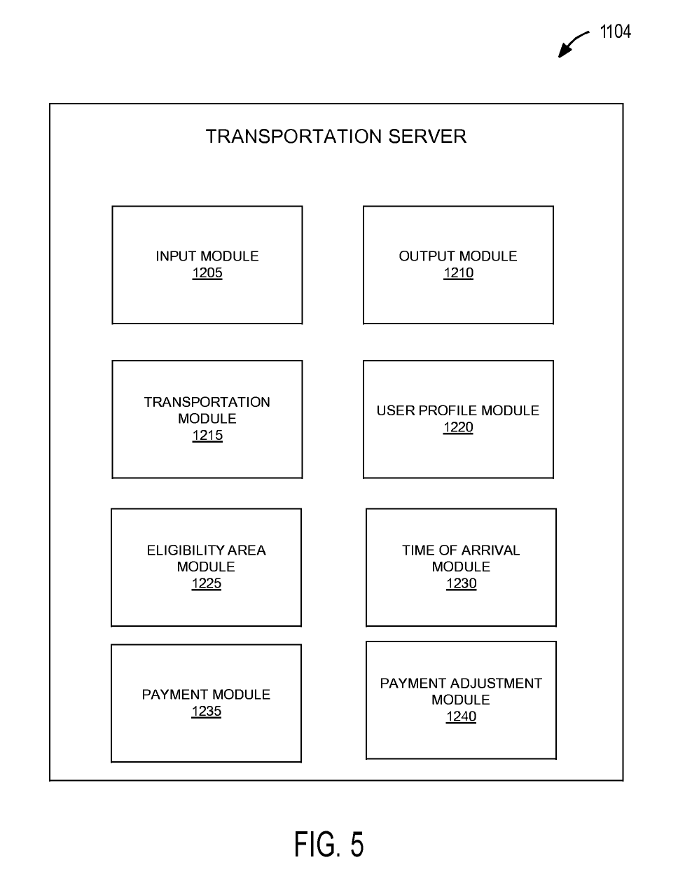

FIG. 5 is a block diagram showing example components of a transportation server 1104. The transportation server 1104 may include an input module 1205, an output module 1210, a transportation module 1215, a user profile module 1220, an eligibility area module 1225, a time of arrival module 1230, a payment module 1235 and a payment adjustment module 1240.

The input module 1205 may be a hardware-implemented module which may receive and process any inputs from one or more components of system 100 of FIG. 1 (e.g., one or more client devices 108, third party server 110, etc.). The inputs may include requests related to transportation, requests for upcoming transportation services, indications of a driver's computing device, payment information, and the like.

The output module 1210 may be a hardware-implemented module which may send any outputs to one or more components of system 100 of FIG. 1 (e.g., one or more client devices 108, third party server 110, etc.). The outputs may include information about available drivers (such as drivers eligible to be booked for upcoming transportation services), passengers requesting transportation, passengers requesting upcoming transportation services, and the like.

The transportation module 1215 may be a hardware-implemented module which may manage, facilitate, and control information related to transportation requests for and acceptances of upcoming transportation services from passengers and drivers, respectively. For example, the transportation module 1215 may determine and generate a list of drivers eligible to be booked to perform an upcoming transportation service(s) for one or more passengers.

The user profile module 1220 may be a hardware-implemented module which may manage, control, store, and access information associated with drivers and/or passengers. The information may be stored in and accessed from the database(s) 106 shown in FIG. 1. The information managed by the user profile module 1220 may include any information associated with a driver(s) and/or passenger(s), such as preferences, vehicle information, background information of a driver, ratings of drivers and/or passengers, payment information of drivers and/or passengers, and the like.

The eligibility area module 1225 may be a hardware-implemented module which may manage, facilitate, and control information related to an eligibility area(s) for driver(s) and/or passenger(s). For example, the eligibility area module 1225 may determine an eligibility area based on at least one or a current location of a driver's computing device, a current location of a passenger's computer device, a pick-up location, a drop-off location, congestion statistics, and the like.

The time of arrival module 1225 may be a hardware-implemented module which may manage, facilitate, and control information related to an expected time of arrival. The time of arrival module 1225 may determine an expected time of arrival based at least on a first amount of time until an in-progress transportation service performed by a driver reaches a drop-off location of a current passenger and a second amount of time required for the driver to travel from the drop-off location of the current passenger to a pick-up location of a new passenger. In some embodiments, an expected time of arrival may be a specific time the driver will most likely arrive at the pick-up location of a new passenger. In various embodiments, an expected time of arrival may be an amount of time until the driver arrives at the pick-up location of a new passenger.

The payment module 1235 may be a hardware-implemented module which may manage, facilitate, and control payments between drivers and passengers. The payment module 1225 may also determine suggested prices associated with requests for upcoming transportation services based on the characteristics of the request (e.g., distance to be traveled, etc.).

The payment adjustment module 1240 may be a hardware-implemented module which may manage, facilitate, determine, identify, and calculate adjustment payments (e.g., a discount, a premium, etc.) based on characteristics of the upcoming transportation service requested by one or more passengers. Such characteristics that influence the amount of the payment be characteristics of the driver and/or the passenger(s).

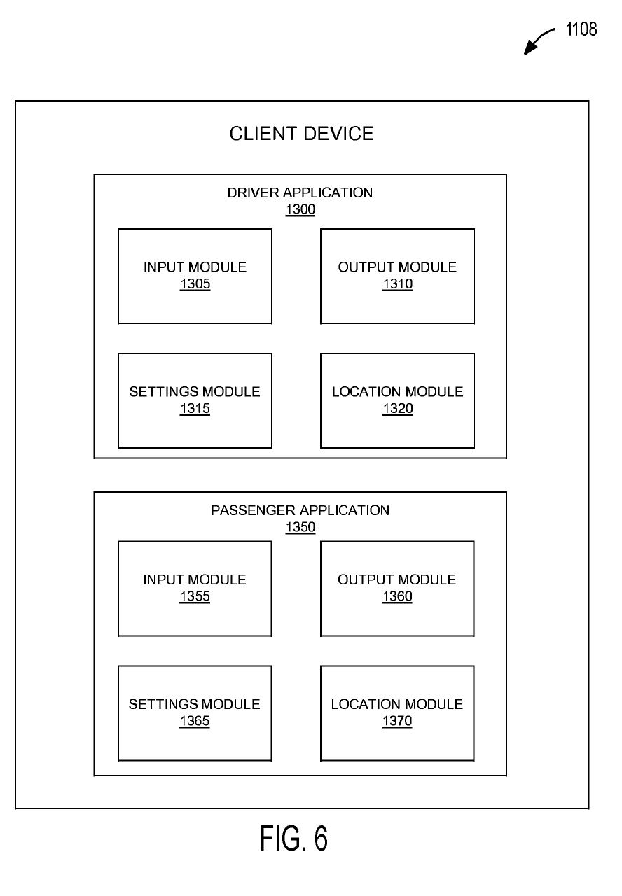

FIG. 6 is a block diagram showing example components of a client device 1108. The client device may be a computing device of a driver(s) and/or a passenger(s) and may include a driver application 1300 and/or a passenger application 1350.

The driver application 1300 may be a software application associated with the transportation server 1104 of FIG. 5. The driver application may include an input module 1305, an output module 1310, a settings module 1315, and a location module 1320.

The input module 1305 may be a hardware-implemented module that may receive and process any inputs from a driver, including inputs related to responses to a request(s) for an upcoming transportation service from one or more passengers, inputs related to preferences of the driver, and the like.

The output module 1310 may be a hardware-implemented module that may send any outputs to one or more components of system 100 of FIG. 1 (e.g., other client devices 108, third party server 110, transportation server 104, etc.). The outputs may include indications of a current location of the client device 108, indications of a current location of the client device 108 within an eligibility area, acceptance and/or denial of requests for upcoming transportation services, and the like.

The settings module 1315 may be a hardware-implemented module that may manage, store, and access settings indicated by a driver, such as starting location, destination location, price, a rating of a passenger, a casual carpool preference, and the like.

The location module 1320 may be a hardware-implemented module that may determine a location of the client device 108. The location module 1320 may determine a location in any suitable manner (e.g., using a third party server 110, GPS capabilities on the client device 108, etc.).

The passenger application 1350 may be a software application associated with the transportation server 1104 of FIG. 5. The passenger application may include an input module 1355, an output module 1360, a settings module 1365, and a location module 1370.

The input module 1355 may be a hardware-implemented module that may receive and process any inputs from a passenger, including inputs related to a request for an upcoming transportation service, inputs related to preferences of the passenger, and the like.

The output module 1360 may be a hardware-implemented module that may send any outputs to one or more components of system 100 of FIG. 1 (e.g., other client devices 108, third party server 110, transportation server 104, etc.). The outputs may include requests for an upcoming transportation service, location of the client device 108, and the like.

The settings module 1365 may be a hardware-implemented module that may manage, store, and access settings indicated by a passenger, such as a starting location, a destination location, a price preference, a driver rating, a driver response rate, a casual carpooling preference, a preferred estimated time of arrival, and the like.

The location module 1370 may be a hardware-implemented module that may determine a location of the client device 108. The location module 1320 may determine a location in any suitable manner (e.g., using a third party server 110, GPS capabilities on the client device 108, etc.).

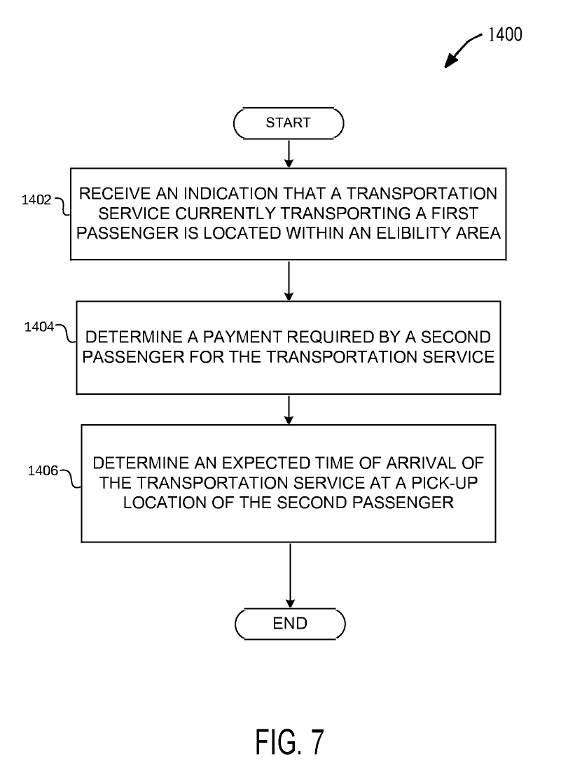

FIG. 7 is a flowchart showing an example method 1400 of queuing a transportation service. The operations of FIG. 7 may be performed by components of the transportation server 1104 of FIG. 5.

In operation 1402, the hardware-implemented input module 1205 may receive an indication that a transportation service currently transporting a first passenger is located within an eligibility area.

In operation 1404, the hardware-implemented payment module 1235 and/or the hardware-implemented payment adjustment module 1240 may determine a payment required by a second passenger for the transportation service. For example, the payment required by the second passenger may be for an upcoming transportation service performed by a driver after the driver completes the transportation service on behalf of the first passenger.

In some embodiments, the payment required by the second passenger may be sent, by the hardware-implemented output module 1201, for display at the second passenger's computing device—where display of the payment required by the second passenger occurs while the driver performs the transportation service on behalf of the first passenger. The payment required by the second passenger may be related to a rating of a driver, a type of driver, a type of vehicle, characteristics of the driver and/or the passenger, and the like.

In operation 1406, the hardware-implemented time of arrival module 1230 may determine an expected time of arrival of the transportation service at a pick-up location of the second passenger. In some embodiments, the hardware-implemented time of arrival module 1230 may determine an expected time of arrival of an upcoming transportation service at the pick-up location of the second passenger.

In some embodiments, the expected time of arrival may be sent, by the hardware-implemented output module 1201, for display at the second passenger's computing device—where display of the expected time of arrival occurs while the driver performs the transportation service on behalf of the first passenger.

It is understood that, in various embodiments, any and/or all of the modules of the transportation server 1104 may be involved in performing operations 1402, 1404 and 1406.

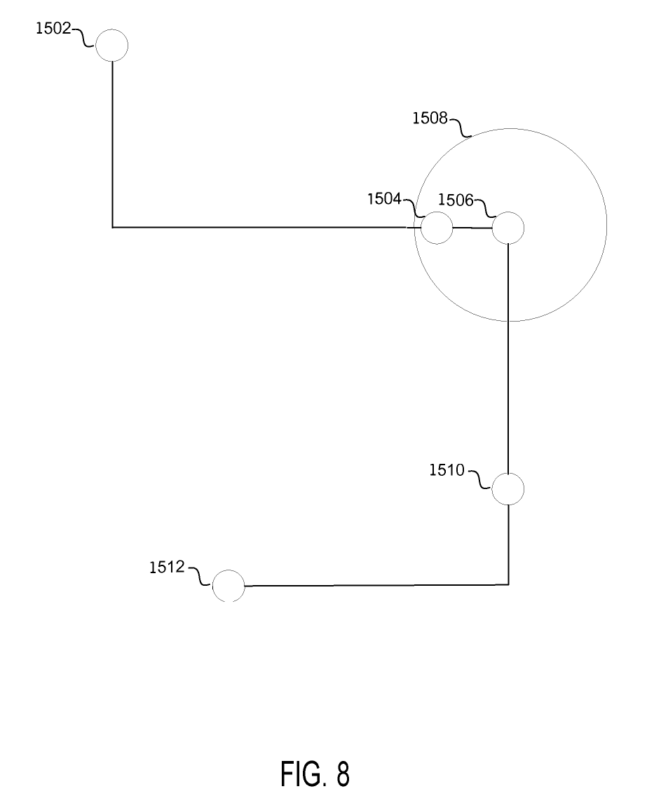

FIG. 8 is a diagram showing an eligibility area, according to some embodiments. FIG. 8 illustrates a route of a current transportation service performed by a driver on behalf of a first passenger that begins at pick-up location 1502 and ends at drop-off location 1506. An eligibility area 1508 surrounds the drop-off location 1506 of the first passenger. A current location 1504 of the driver's computing device is inside the eligibility area 1508. Based on the current location 1504 of the driver's computing device being within the eligibility area 1508, the driver is eligible to be booked for an upcoming transportation service while the driver performs the current transportation service on behalf of the first passenger.

FIG. 8 further illustrates a route of an upcoming transportation service that begins at a pick-up location 1510 of a second passenger and ends at a drop-off location 1512 of the second passenger. In some embodiments, the second passenger may be able to book the driver for the upcoming transportation service based on the second passenger's pick-up location 1510. For example, the driver is eligible to be booked for the upcoming transportation service by the second passenger based on a distance between the second passenger's pick-up location 1510 and the first passenger's drop-off location 1506. In various embodiments, the driver is eligible to be booked for the upcoming transportation service by the second passenger based on a distance between the second passenger's pick-up location 1510 and the eligibility area 1508.

In some embodiments, a request for an upcoming transportation service from the second passenger is a request for a trip performed by the driver from pick-up location 1510 to drop-off location 1512. In various embodiments, an expected time of arrival is based at least on an amount of time for the driver to travel from current location 1504 to drop-off location 1506 and an amount of time to travel from drop-off location 1506 to pick-up location 1510.

In some embodiments, a request for an upcoming transportation service may relate to an estimated time of arrival, a rating of a driver, a type of driver, a type of vehicle, and the like, and the request may be sent to drivers associated with one or more of these characteristics.

Example systems and methods for improved shared transportation services and improved queued transportation services are described. In the following description, for purposes of explanation, numerous specific details are set forth in order to provide a thorough understanding of example embodiments. It will be evident, however, to one skilled in the art that the present technology may be practiced without these specific details.

Embodiments described below provide for an automated method for convenient, efficient allocation of personal transportation and other on-demand transportation resources and transportation services over a data communications network. These embodiments may also be extended for use in a variety of scenarios in which a mobile resource requires scheduling and allocation of that resource.

A transportation server may provide an online environment in which drivers and users (e.g. passengers) may connect with one another for transportation services. The transportation server determines payments required by each passenger of a transportation service. In some embodiments, a transportation service may comprise a trip (or route) from a starting location to a destination location. In some embodiments, a transportation service may be a trip (or route) from a pick-up location associated with a passenger to a drop-off location associated with the passenger. In various embodiments, an upcoming transportation service may be a transportation service to be performed by a particular driver, from a pick-up location to a drop-off location, after the particular driver completes a transportation service that is currently in progress.

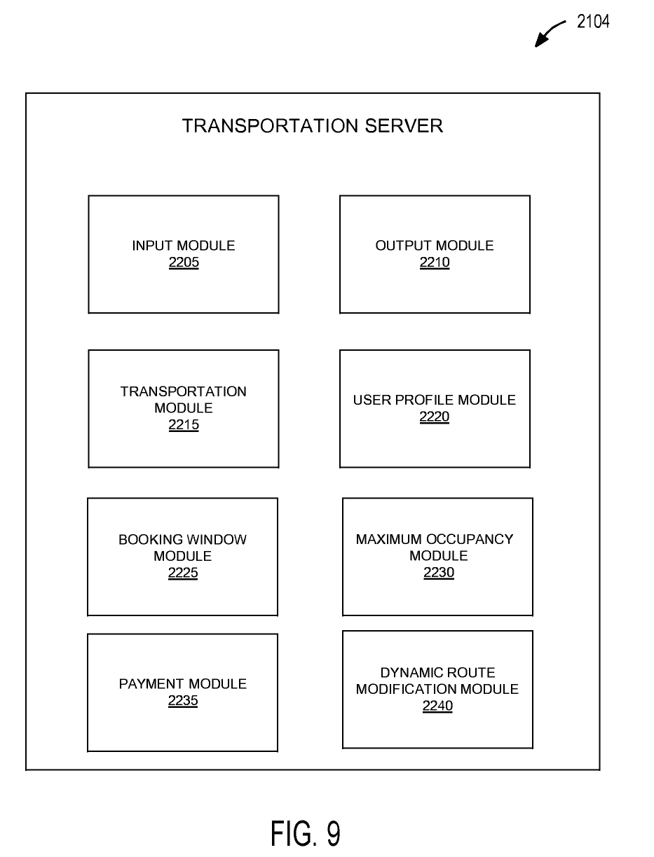

FIG. 9 is a block diagram showing example components of a transportation server 2104. The transportation server 2104 may include an input module 2205, an output module 2210, a transportation module 2215, a user profile module 2220, a booking window module 2225, a maximum occupancy module 2230, a payment module 2235 and a dynamic route modification module 2240.

The input module 2205 is a hardware-implemented module to receive and process any inputs from one or more components of system 100 of FIG. 1 (e.g., one or more client devices 108, third party server 110, etc.). The inputs may include requests related to transportation, requests for upcoming transportation services, indications of a driver's computing device, payment information, and the like.

The output module 2210 is a hardware-implemented module to send any outputs to one or more components of system 100 of FIG. 1 (e.g., one or more client devices 108, third party server 110, etc.). The outputs may include information about available drivers (such as drivers eligible to be booked for upcoming transportation services), passengers requesting transportation, passengers requesting upcoming transportation services, and the like.

The transportation module 2215 is a hardware-implemented module to manage, facilitate, and control information related to transportation requests for and acceptances of upcoming transportation services from passengers and drivers, respectively. For example, the transportation module 2215 may determine and generate a list of drivers eligible to be booked to perform an upcoming transportation service(s) for one or more passengers.

The user profile module 2220 is a hardware-implemented module to manage, control, store, and access information associated with drivers and/or passengers.

The information may be stored in and accessed from the database(s) 106 shown in FIG. 1. The information managed by the user profile module 2220 may include any information associated with a driver(s) and/or passenger(s), such as preferences, vehicle information, background information of a driver, ratings of drivers and/or passengers, payment information of drivers and/or passengers, and the like.

The booking window module 2225 is a hardware-implemented module to manage, facilitate, and control information related to booking a user(s) for a shared transportation service. In some embodiments, the booking window module 2225 identifies a user with a desired pick-up and/or drop-off location that is within a threshold of proximity to at least a portion of a route of a shared transportation service that has already been booked by another user. In other embodiments, the booking window module 2225 identifies a user with a desired pick-up and/or drop-off location that is within a threshold of proximity to at least a portion of a route of a shared transportation service currently transporting one or more users to their respective desired drop-off locations.

The maximum occupancy module 2225 is a hardware-implemented module to manage, facilitate, and control information related to a maximum number of users allowed on a shared transportation service. In some embodiments, the maximum occupancy module 2225 identifies a maximum number of occupants allowed for a shared transportation service that has already been booked by one or more users. In some embodiments, the maximum occupancy module 2225 identifies a maximum number of occupants allowed a shared transportation service currently transporting one or more user to their respective desired drop-off locations. In some embodiments, the maximum occupancy module 2225 determines when a current occupancy of a shared transportation service is below a maximum number of occupancy. In some embodiments, the maximum occupancy module 2225 determines when a current occupancy of a shared transportation service is equal to a maximum number of occupancy. In some embodiments, the maximum occupancy module 2225 determines when a shared transportation service will be available to be booked by one or more additional users in order for the shared transportation service to reach the maximum number of occupancy during at least a portion of a route the shared transportation service.

The payment module 2235 is a hardware-implemented module to manage, facilitate, and control payments between drivers and passengers. In some embodiments, payment module 2225 determines suggested prices associated with shared transportation services that have already been booked by one or more users. In some embodiments, payment module 2225 determines suggested prices associated with shared transportation services currently transporting one or more users to their respective desired drop-off locations.

In some embodiments, the payment module 2235 determines prices based at least on one of: the one or more users who booked the shared transportation service, at least a portion of a current route of the shared transportation service, at least a portion of a modified route of the shared transportation service, a current location of the shared transportation service, a pick-up location and/or drop-off location of the one or more users and a requested pick-up time and/or a requested drop-off time of the one or more users.

The dynamic route modification module 2240 is a hardware-implemented module to manage, facilitate, determine, identify, and calculate modifications to a route of a shared transportation service. In some embodiments, the dynamic route modification module 2240 modifies at least a portion of a route of a shared transportation service already booked by a user based on a pick-up location and/or drop-off location of an additional user. In some embodiments, the dynamic route modification module 2240 modifies at least a portion of a route of a shared transportation service currently transporting one more users to their respective desired drop-off locations based on a pick-up location and/or drop-off location of an additional user.

In some embodiments, the dynamic route modification module 2240 modifies at least a portion of a route of a shared transportation service already booked by a user based on a desired pick-up time and/or a desired drop-off time of an additional user. In some embodiments, the dynamic route modification module 3240 modifies at least a portion of a route of a shared transportation service currently transporting one more users to their respective desired drop-off locations based on a pick-up time and/or drop-off time of an additional user.

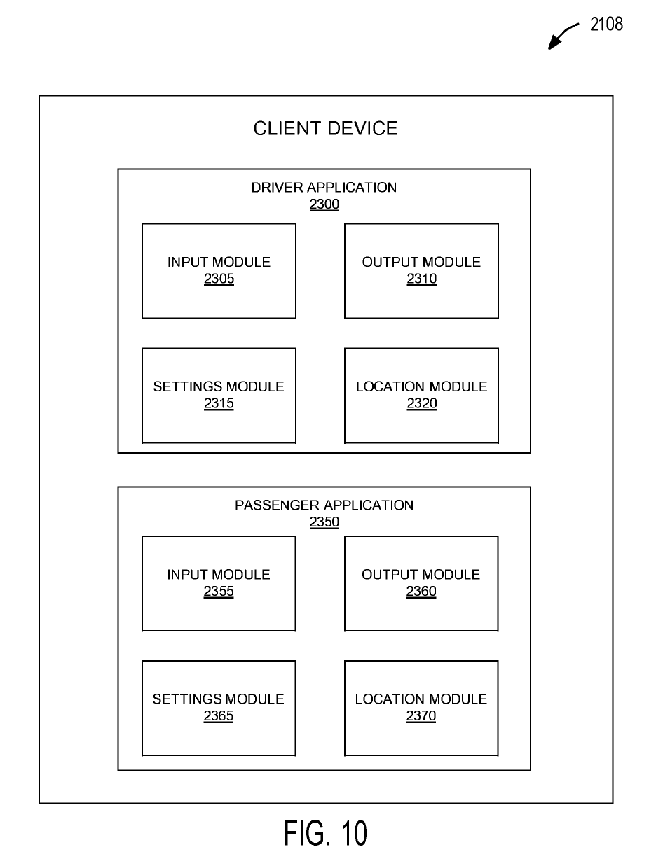

FIG. 10 is a block diagram showing example components of a client device 2108. The client device may be a computing device of a driver(s) and/or a passenger(s) and may include a driver application 2300 and/or a passenger application 2350.

The driver application 2300 is a software application associated with the transportation server 2104 of FIG. 9. The driver application 2300 includes an input module 2305, an output module 2310, a settings module 2315, and a location module 2320.

The input module 2305 is a hardware-implemented module to receive and process any inputs from a driver, including inputs related to responses to a request(s) for any kind of transportation service from one or more users (e.g. passengers), inputs related to preferences of the driver, and the like.

The output module 2310 is a hardware-implemented module to send any outputs to one or more components of system 100 of FIG. 1 (e.g., other client devices 108, third party server 110, transportation server 104, etc.). The outputs may include indications of a current location of the client device 108, indications of a current location of the client device 108 with respect to a pick-up location(s) and/or drop-off location(s), acceptance and/or denial of requests for transportation services, and the like.

The settings module 2315 is a hardware-implemented module to manage, store, and access settings indicated by a driver, such as starting location, destination location, price, a rating of a passenger, a casual carpool preference, and the like.

The location module 2320 is a hardware-implemented module that may determine a location of the client device 108. The location module 2320 may determine a location in any suitable manner (e.g., using a third party server 110, GPS capabilities on the client device 108, etc.).

The passenger application 2350 is a software application associated with the transportation server 2104 of FIG. 9. The passenger application 2350 includes an input module 2355, an output module 2360, a settings module 2365, and a location module 2370.

The input module 2355 is a hardware-implemented module to receive and process any inputs from a passenger (e.g. a user), including inputs related to a request for any kind of transportation service, inputs related to preferences of the passenger, and the like.

The output module 2360 is a hardware-implemented module to send any outputs to one or more components of system 100 of FIG. 1 (e.g., other client devices 108, third party server 110, transportation server 104, etc.). The outputs may include requests for a transportation service, location of the client device 108, and the like.

The settings module 2365 is a hardware-implemented module to manage, store, and access settings indicated by a passenger, such as a pick-up location, a drop-off location, a price preference, a driver rating, a driver response rate, a casual carpooling preference, a preferred estimated time of arrival, and the like.

The location module 2370 is a hardware-implemented module to determine a location of the client device 2108. The location module 2320 may determine a location in any suitable manner (e.g., using a third party server 110, GPS capabilities on the client device 108, etc.).

### Expanded Matching Window and Dynamic Re-Routing

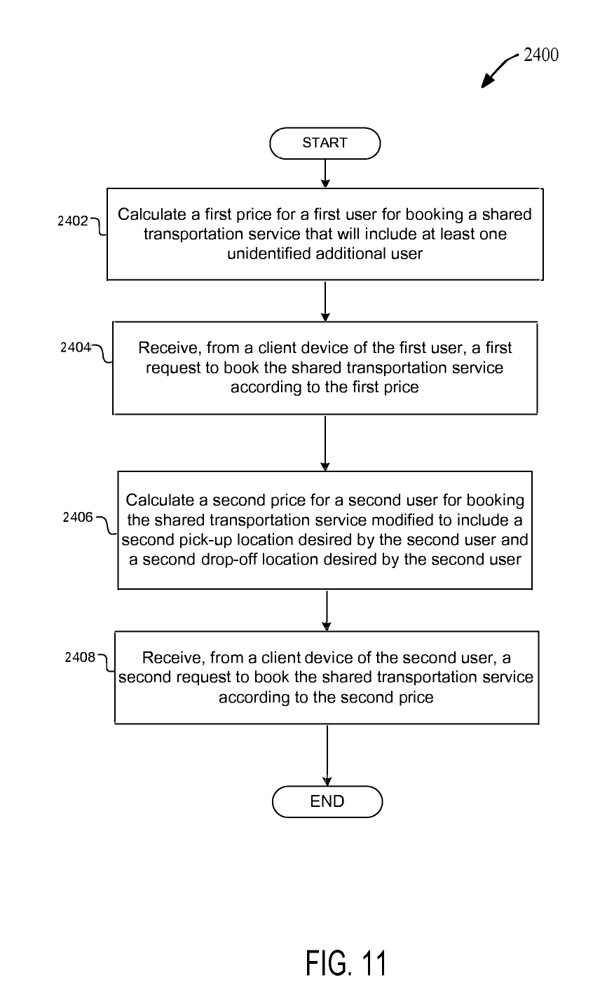

FIG. 11 is a flowchart 2400 showing an example method of dynamically modifying a route of a shared transportation service, according to some embodiments. In some embodiments, the operations of FIG. 11 are performed by components of the transportation server 2104 of FIG. 9.

In operation 2402, the transportation server 2104 calculates a first price for a first user for booking a shared transportation service that will include at least one unidentified additional user (e.g. an additional user(s) that has yet to book the shared transportation service). It is understood that the transportation server 2104 calculates a discount price for the first user based on an expectation that the transportation server 2104 will identify one or more additional users who will join the shared transportation service.

The shared transportation service includes a route that includes a first pick-up location desired by the first user and a first drop-off location desired by the first user. In some embodiments, the route of the shared transportation service also accounts for a pick-up time desired by the first user and a desired drop-off time desired by the first user.

In operation 2404, the transportation server 2104 receives, from a client device of the first user, a first request to book the shared transportation service according to the first price.

In operation 2406, the transportation server 2104 calculates a second price for a second user for booking the shared transportation service modified to include a second pick-up location desired by the second user and a second drop-off location desired by the second user. In some embodiments, the shared transportation service is also modified to account for a pick-up time desired by the second user and a desired drop-off time desired by the second user. It is understood that the transportation server 2104 also calculates a discount price for the second user since the first user has already booked the shared transportation service according to the first price.

In operation 2408, the transportation server 2104 receives, from a client device of the second user, a second request to book according to the second price the shared transportation service modified to include the second pick-up location and the second drop-off location.

It is understood that, in various embodiments, any and/or all of the modules of the transportation server 2104 may be involved in performing operations 2402, 2404, 2406 and 2408.

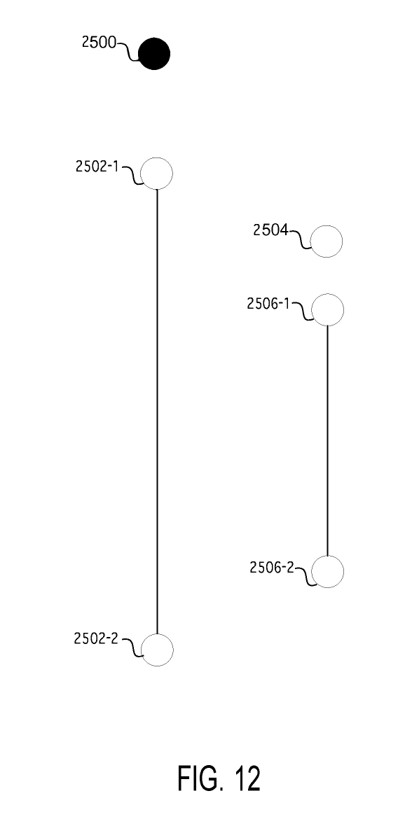

FIG. 12 is a diagram showing a user booking a shared transportation service that is currently transporting another user to a drop-off location, according to some embodiments. In some embodiments, the actions, events, calculations and route modifications discussed below with respect to FIG. 12 are performed by components of the transportation server 2104 of FIG. 9.

FIG. 12 illustrates a first moment of time 2500 at which a first user books a shared transportation service from pick-up location 2502-1 to drop-off location 2502-2. FIG. 12 also illustrates a second moment of time 2504 at which a second user books the shared transportation service from pick-up location 2506-1 to drop-off location 2506-2. The second moment of time 2504 at which the second user books the shared transportation service occurs after the shared transportation service arrives at the pick-up location 2502-1 desired by the first user.

In various embodiments, the transportation server 2104 dynamically modifies a route of a shared transportation service to include pick-up locations and drop-off locations requested by multiple users. The transportation server 2104 receives an indication from a client device of a first user that the first user is seeking transportation from a first pick-up location 2502-1 to a first drop-off location 2502-2. The transportation server 2104 defines the shared transportation service according to a route from the first pick-up location 2502-1 to the first drop-off location 2502-2 desired by the first user.

The transportation server 2104 defines the shared transportation service as available to be booked and/or to be routed towards additional, unknown pick-up locations and one or more additional, unknown drop-off locations desired by respective, unidentified additional users. Once identified by the transportation server 2104, the additional users will be able to book rides on the shared transportation service. In some embodiments, one or more additional users will accompany the first user during at least a portion of the route of the shared transportation service.

Prior to identifying the additional users of the shared transportation service, the transportation server 2104 calculates a first price for the first user to book the shared transportation service to transport the first user along a route that includes the first pick-up location 2502-1 and the first drop-off location 2502-2. Since the shared transportation service is defined according to a route that can be dynamically modified to include pick-up and drop-off locations of yet to be identified additional users who will join the shared transportation service, the transportation server 2104 calculates the first price at a discount price. The transportation server 2104 receives a first request from the client device of the first user to book the shared transportation service according to the first price.

In some embodiments, in order to calculate the first price, the transportation server 2104 accesses data to determine the first price. The data may include, but is not limited to: current traffic data, past traffic data, predicted future traffic data, data that describes when and/or where other users tend to join shared transportation services, data representative of current locations of other users seeking transportation, data representative of current conditions along the route from the first pick-up location 2502-1 to the first drop-off location 2502-2 desired by the first user and data representative of current locations of one or more drivers.

The transportation server 2104 receives an indication from a client device of a second user(s) that the second user is seeking transportation from a second pick-up location 2506-1 to a second drop-off location 2506-2. In order to determine a second price for the second user, the transportation server 2104 dynamically modifies the shared transportation service. For example, the transportation server 2104 dynamically modifies the route of the shared transportation service with respect to a current location of the shared transportation service. The route is modified to also include the second pick-up location 2506-1 and the second drop-off location 2506-2 desired by the second user. In some embodiments, the transportation server 2104 modifies the route based at least on a current location of the shared transportation service with respect to the second pick-up location 2506-1 and/or the second drop-off location 2506-2 desired by the second user. In some embodiments, the transportation server 2104 modifies the route based at least on a current location of the shared transportation service with respect to a pick-up time desired by the second user and/or a drop-off time desired by the second user.

The transportation server 2104 calculates a second price for the second user for the modified, shared transportation service. Since the first user has already booked the shared transportation service according to the first price, the transportation server 2104 calculates the second price as a discount price as well. The transportation server 2104 receives a request from the client device of the second user to book the modified, shared transportation service according to the second price.

In some embodiments, the transportation server 2104 calculates the second price for the second user after the shared transportation service has calculated the first price for the first user. In some embodiments, the transportation server 2104 calculates the second price for the second user while the shared transportation service is currently en route to the first pick-up location 2502-2. In some embodiments, the transportation server 2104 calculates the second price for the second user while the shared transportation service is currently en route from the first pick-up location 2502-1 to the first drop-off location 2502-2 desired by the first user. In some embodiments, the transportation server 2104 calculates the second price for the second user based at least on a current location of the shared transportation service with respect to the second pick-up location 2506-1 and/or the second drop-off location 2506-2 desired by the second user.

In some embodiments, in order to calculate the second price for the second user, the transportation server 2104 accesses and utilizes the same type of data used to determine the first price. In order to calculate a price of any additional user, the transportation server 2104 accesses and utilizes the same type of data used to determine the first price. It is further understood that, in various embodiments, the transportation server 2104 accesses and utilizes the same type of data used in price calculation for determining and modifying at least a portion of a route.

### Ride Chaining

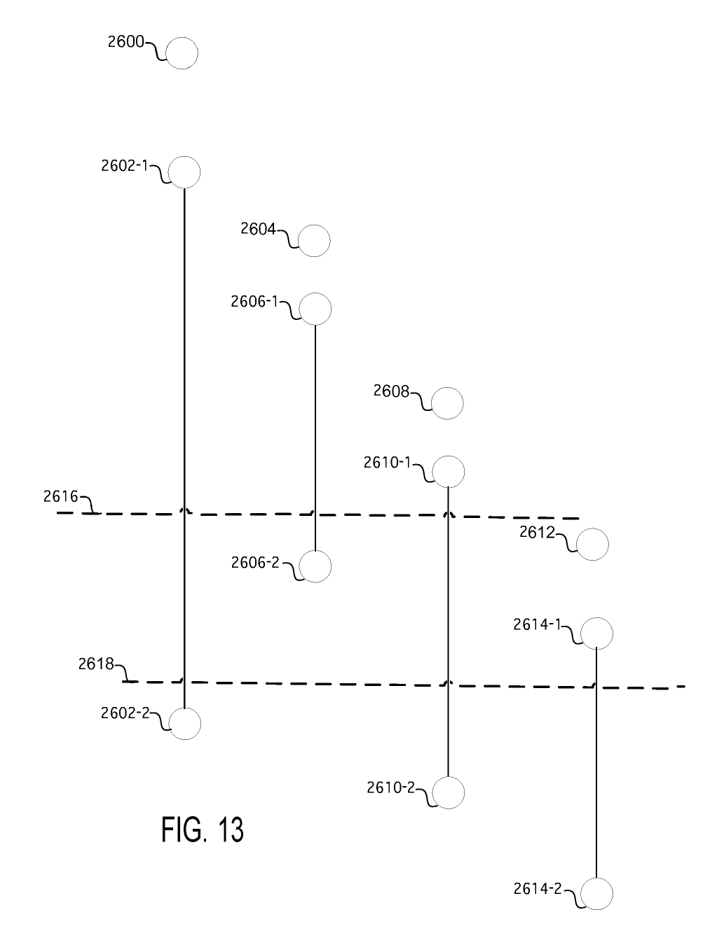

FIG. 13 is a diagram showing a shared transportation service dynamically modified to allow for a maximum number of users to utilize the shared transportation service. In some embodiments, the actions, events, calculations and route modifications discussed below with respect to FIG. 13 are performed by components of the transportation server 2104 of FIG. 9.

FIG. 13 illustrates a first moment of time 2600 at which a first user books a shared transportation service from pick-up location 2602-1 to drop-off location 2602-2. FIG. 13 also illustrates a second moment of time 2604 at which a second user books the shared transportation service from pick-up location 2606-1 to drop-off location 2606-2. FIG. 13 also illustrates a third moment of time 2608 at which a third user books the shared transportation service from pick-up location 2610-1 to drop-off location 2610-2. FIG. 13 also illustrates a fourth moment of time 2612 at which a fourth user books the shared transportation service from pick-up location 2614-1 to drop-off location 2614-2.

The second moment of time 2604 at which the second user books the shared transportation service occurs after the shared transportation service arrives at the pick-up location 2602-1 desired by the first user. The third moment of time 2608 at which the third user books the shared transportation service occurs after the shared transportation service arrives at the pick-up location 2606-1 desired by the second user. The fourth moment of time 2612 at which the fourth user books the shared transportation service occurs before the shared transportation service arrives at the drop-off locations 2602-2, 2606-2, 2610-2 desired by the first, second and third users, respectively.

In some embodiments, the transportation server 2104 defines and/or identifies a maximum number of users that can concurrently use the shared transportation service. According to a non-limiting example, as illustrated in FIG. 13, the shared transportation service may be an automobile that has a maximum occupancy of 3 seats that can be concurrently occupied during at least a portion of a route of the shared transportation service. The transportation server 2104 dynamically modifies a route of the shared transportation service so that the shared transportation service experiences the maximum occupancy during at least a portion of the route.

Reference numerals 2616 and 2618 of FIG. 13 indicate that the maximum occupancy has been reached during at least a portion of the route of the shared transportation service. Reference numeral 2616 indicates that transportation server 2104 has determined a route for the shared transportation service that at least includes drop-off locations 2602-2, 2606-2, 2610-2 whereby the first, second and third users accompany each other. Reference numeral 2618 indicates that transportation server 2104 has determined a modified route for the shared transportation service that includes drop-off locations 2602-2, 2610-2, 2614-2 whereby the first, third and fourth users accompany each other.

It is understood that, in various embodiments, the transportation server 2104 receives a current location of the shared transportation service as the shared transportation service is en route to the drop-off location 2606-2 desired by the second user. Based on the current location of the shared transportation service, the transportation server 2104 determines the shared transportation service will be under the maximum occupancy after the shared transportation service arrives at the drop-off location 2606-2.

Prior to the shared transportation service's arrival at the drop-off location 2606-2, the transportation server 2104 receives an indication from a client device of the fourth user that the fourth user is seeking transportation from pick-up location 2614-1 to drop-off location 2614-2. Based on at least one of (a) the current route and (b) the current location of the shared transportation service, (c) the current time, (d) the pick-up location 614-1, (e) the drop-off location 614-2 and (f) additional data related to past, current and/or predicted future traffic, the transportation server 2104 determines a new route for the shared transportation service that includes locations 2602-2, 2610-2, 2614-1 and 2614-2 such that the shared transportation service will again reach the maximum occupancy by having the fourth user accompany the first user and the third user (See Reference Numeral 2618).

The transportation server 2104 calculates a price for the fourth user to book the shared transportation service. The transportation server 2104 receives from a client device of the fourth user, a request to book according to the fourth price the shared transportation service modified to include the pick-up location 2614-1 and the drop-off location 2614-2 requested by the fourth user.

### Package Delivery

It is understood that the transportation server 2104 can modify a route of a shared transportation service to include a pick-up location and/or a delivery location of one or more packages. In some embodiments, route modification can be made to account for a desired pick-up time of the one or more packages and/or a desired delivery time of the one or more packages. In some embodiments, the transportation server 2104 modifies a route to include a pick-up location of a package that is to be delivered at a delivery location at a desired time. The transportation server 2104 may further modify the route to arrive at a pick-up location and drop-off location of one or more additional users (and/or one or more additional packages) before the delivery of the package.

### Carpooling

It is understood that the transportation server 2104 can modify a route of a shared transportation service based on a starting location and a destination location desired by a driver of the shared transportation service. In other words, the transportation server 2104 modifies the route to account for the starting location and a destination location desired by the driver as additional users book and join the shared transportation service.

### Number of Parties

It is understood that the transportation server 2104 can modify a route of a shared transportation service based on a particular pick-up location desired by a plurality of additional users. In some embodiments, the plurality of additional user may also desire a same drop-off location. In other embodiments, the plurality of additional user may desire different drop-off locations even though they joined the shared transportation service at the same particular pick-up location.

It is understood that the transportation server 2104 can modify a route of a shared transportation service based on a particular drop-off location desired by a plurality of additional users. In some embodiments, the plurality of additional user may join the shared transportation service at different respective pick-up locations even though they desired the same particular drop-off location.

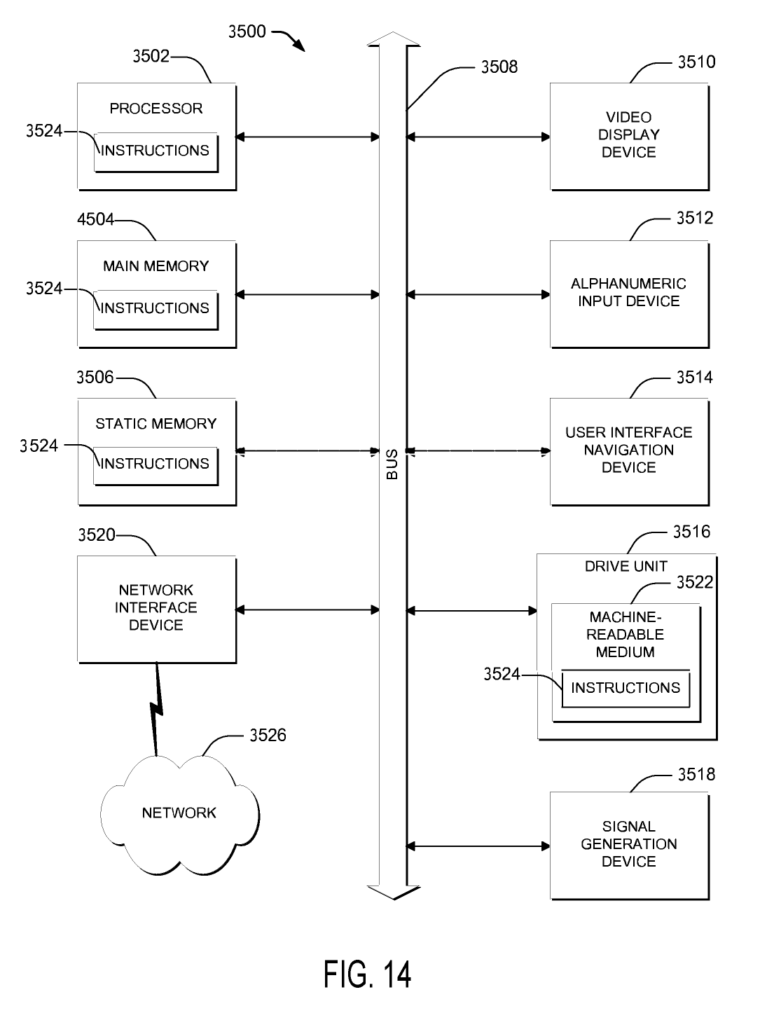

FIG. 14 is a block diagram of a machine in the example form of a computer system 3500 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 3500 includes a processor 3502 (e.g., a central processing unit (CPU), a graphics processing unit (GPU) or both), a main memory 3504, and a static memory 3506, which communicate with each other via a bus 3508. Computer system 3500 may further include a video display device 3510 (e.g., a liquid crystal display (LCD) or a cathode ray tube (CRT)). Computer system 3500 also includes an alphanumeric input device 3512 (e.g., a keyboard), a user interface (UI) navigation device 3514 (e.g., a mouse or touch sensitive display), a disk drive unit 3516, a signal generation device 3518 (e.g., a speaker) and a network interface device 3520.

Disk drive unit 3516 includes a machine-readable medium 3522 on which is stored one or more sets of instructions and data structures (e.g., software) 3524 embodying or utilized by any one or more of the methodologies or functions described herein. Instructions 3524 may also reside, completely or at least partially, within main memory 3504, within static memory 3506, and/or within processor 3502 during execution thereof by computer system 3500, main memory 3504 and processor 3502 also constituting machine-readable media.

While machine-readable medium 3522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 3524 may further be transmitted or received over a communications network 3526 using a transmission medium. Instructions 3524 may be transmitted using network interface device 3520 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method, comprising:
receiving, by a hardware-implemented transportation server, a request to transport a passenger from a first location to a second location;
determining, by the hardware-implemented transportation server, a first route from the first location to the second location;
directing, by the hardware-implemented transportation server, a driver to drive to the first location to pick up the passenger;
after the driver has arrived at the first location, directing, by the hardware-implemented transportation server, the driver to drive from the first location to the second location;
while the driver is traveling from the first location to the second location and before the driver has arrived at the second location, receiving, by the hardware-implemented transportation server, a request to deliver a package from a third location to a fourth location;
based on a drop-off time of the package, determining, by the hardware-implemented transportation server, to drop-off the package before the passenger;
directing, by the hardware-implemented transportation server, the driver to deviate from the first route and drive to the third location to pick up the package;
after the driver has arrived at the third location, directing, by the hardware-implemented transportation server, the driver to drive to the fourth location to drop off the package; and
after the driver has arrived at the fourth location, directing, by the hardware-implemented transportation server, the driver to drive to the second location to drop off the passenger.

2. The method of claim 1, further comprising determining that the third location is within a threshold of proximity to at least a portion of the first route.

3. A method, comprising:
receiving, by a hardware-implemented transportation server, a request to transport a first passenger from a first location to a second location;
determining, by the hardware-implemented transportation server, a first route from the first location to the second location;
directing, by the hardware-implemented transportation server, a driver to drive to the first location to pick up the first passenger;
after the driver has arrived at the first location, directing, by the hardware-implemented transportation server, the driver to drive from the first location to the second location to drop off the first passenger;
while the driver is traveling from the first location to the second location, receiving, by the hardware-implemented transportation server, a request to transport a second passenger from a third location to a fourth location, the second location being different from the third location;
based on a specified criteria being satisfied, determining, by the hardware-implemented transportation server, that the driver is eligible to be booked for an upcoming transportation service to transport the second passenger from the third location to the fourth location;
after the driver has arrived at the second location, directing, by the hardware-implemented transportation server, the driver to drive from the second location to the third location; and
after the driver has arrived at the third location, directing, by the hardware-implemented transportation server, the driver to drive from the third location to the fourth location to drop off the second passenger.

4. The method of claim 3, wherein the specified criteria is that a current location of the driver is within an eligibility area that surrounds the second location.

5. The method of claim 3, wherein the specified criteria is based on a distance between the third location and the second location.

6. The method of claim 3, wherein the specified criteria is based on a distance between the third location and an eligibility area that surrounds the second location.

7. A method, comprising:
receiving, from a client device of a first passenger, a first request for a shared transportation service;
receiving, from a client device of a second passenger, a second request to join the shared transportation service;
transmitting, from a server, data to the client device of the first passenger, the data indicating a selectable option to cancel the second request to join the shared transportation service;
in response to receiving an indication from the client device of the first passenger that the selectable option was selected to cancel the second request to join the shared transportation service, cancelling the second request, otherwise:
defining, by the server, a shared transportation service trip to be performed by a driver based on the first and second requests, the shared transportation service trip transporting the first passenger to a first location and transporting the second passenger to a second location;
while the first and second passengers are traveling to their respective destinations, receiving a request to transport a third passenger from a third location to a fourth location, the third location being different from the first and second locations;
directing the driver to the first location to drop off the first passenger;
after the driver has arrived at the first location, directing the driver to the second location to drop off the second passenger;
after the driver has arrived at the second location, directing the driver to the third location to pick up the third passenger; and
after the driver has arrived at the third location, directing the driver to the fourth location to drop off the third passenger.

8. The method of claim 7, wherein the third location is located within an eligibility area that surrounds the second location.
